(19) United States
(12) Patent Application Publication
(10) Pub. No.: US 2011/0265166 A1
(43) Pub. Date: Oct. 27, 2011

(54) INTEGRATED AUTHENTICATION

(75) Inventors: Will D. Franco, Miami, FL (US); Sunning Chung Ning Go, Waterloo (CA)

(73) Assignee: RESEARCH IN MOTION LIMITED, Waterloo (CA)

(21) Appl. No.: 13/052,747

(22) Filed: Mar. 21, 2011

Related U.S. Application Data
(60) Provisional application No. 61/328,083, filed on Apr. 26, 2010.

(51) Int. Cl. H04L 9/32; G06F 21/00

(52) U.S. Cl. 726/7

(57) ABSTRACT

Authentication to a network resource of a user associated with a mobile communication device is disclosed. A message is received from a device. The message includes a hardware identifier of the device, and identifies a network resource as the destination of the message. A user identity is associated with the hardware identifier, and is sufficient to obtain session credentials from an authentication resource. Session credentials are obtained from the authentication resource. The session credentials are used to authenticate the associated user identity to the network resource.

### CROSS REFERENCE TO RELATED APPLICATIONS

This application claims the benefit of U.S. Provisional Application No. 61/328,083, filed Apr. 26, 2010, the entire disclosure of which is hereby incorporated herein by reference in its entirety.

### FIELD OF THE TECHNOLOGY

The technology disclosed herein (the “technology”) relates to providing a mobile communications device (also referred to as the “device”) access to access-controlled intranet resources without requiring a user to enter access credentials for the resource. More specifically, the technology relates to using a proxy not only to allow the device to interface with an access-controlled intranet resource, but also using the proxy to obtain credentials needed for interaction.

### BRIEF DESCRIPTION OF THE DRAWINGS

FIG. 1 illustrates a communication system including a mobile communication device to which example embodiments of the technology can be applied.

FIG. 2 illustrates a wireless connector system in accordance with one embodiment of the technology.

FIG. 3 illustrates an exemplary mobile communication device used in embodiments of the technology.

FIG. 4 illustrates a device, such as in FIG. 3, in detail.

FIG. 5 illustrates a mobile data service of a wireless connector system of the technology in the context of the communication system.

FIG. 6 illustrates a method for integrated authentication in support of HTTP requests from a device, such as in FIG. 3, to an application server.

FIG. 7 illustrates a method for integrated authentication in support of file requests from a device, such as in FIG. 3, to an intranet resource.

### DETAILED DESCRIPTION

Reference will now be made in detail to embodiments of the technology. Each example is provided by way of explanation of the technology only, not as a limitation of the technology. It will be apparent to those skilled in the art that various modifications and variations can be made in the present technology without departing from the scope or spirit of the technology. For instance, features described as part of one embodiment can be used on another embodiment to yield a still further embodiment. Thus, it is intended that the present technology cover such modifications and variations that come within the scope of the technology.

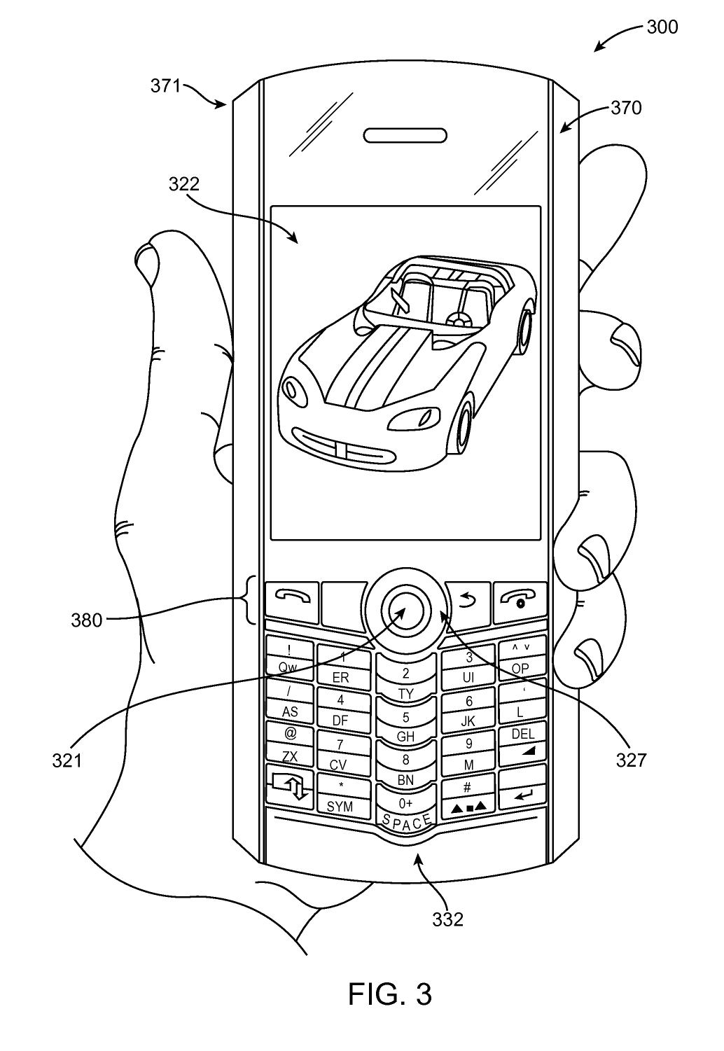

As may be appreciated from FIG. 3, an exemplary mobile communication device 300 comprises a lighted display 322 located above a keyboard 332 constituting a user input means and suitable for accommodating textual input to the device 300. The front face 370 of the device 300 has a navigation row 380. As shown, the device 300 is of uni-body construction, also known as a “candy-bar” design.

The device 300 may include an auxiliary input that acts as a cursor navigation tool 327 and that may be also exteriorly located upon the front face 370 of the device 300. Its front face location allows the tool to be thumb-actuable, e.g., like the keys of the keyboard 332. Some embodiments provide the navigation tool 327 in the form of a trackball 321 that may be utilized to instruct two-dimensional screen cursor movement in substantially any direction, as well as act as an actuator when the trackball 321 is depressed like a button. The placement of the navigation tool 327 may be above the keyboard 332 and below the display screen 322; here, it may avoid interference during keyboarding and does not block the operator's view of the display screen 322 during use.

The device 300 may be configured to send and receive messages. The device 300 includes a body 371 that may, in some embodiments, be configured to be held in one hand by an operator of the device 300 during text entry. A display 322 is included that is located on a front face 370 of the body 371 and upon which information is displayed to the operator, e.g., during text entry. The device 300 may also be configured to send and receive voice communications such as mobile telephone calls. The device 300 also can include a camera (not shown) to allow the user to take electronic photographs that can be referred to as photos or pictures.

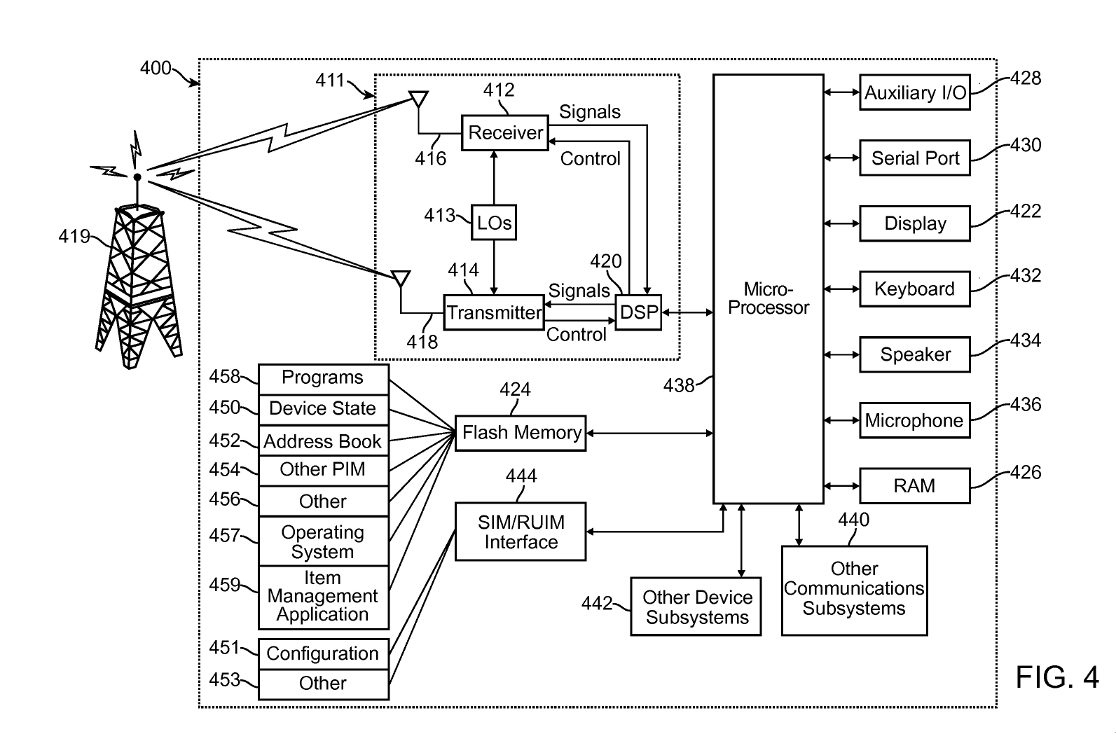

Referring to FIG. 4, a block diagram of a communication device in accordance with an exemplary embodiment is illustrated. As shown, the device 400, such as 300 and 103, includes a microprocessor 438 that controls the operation of the communication device 400. A communication subsystem 411 performs communication transmission and reception with the wireless network 419. The microprocessor 438 further can be communicatively coupled with an auxiliary input/output (I/O) subsystem 428 that can be communicatively coupled to the communication device 400. In at least one embodiment, the microprocessor 438 can be communicatively coupled to a serial port (for example, a Universal Serial Bus port) 430 that can allow for communication with other devices or systems via the serial port 430. A display 422 (e.g., 322) can be communicatively coupled to microprocessor 438 to allow for displaying of information to an operator of the communication device 400. When the communication device 400 is equipped with a keyboard 432 (e.g., 332), the keyboard can also be communicatively coupled with the microprocessor 438. The communication device 400 can include a speaker 434, a microphone 436, random access memory (RAM) 426, and flash memory 424 all of which may be communicatively coupled to the microprocessor 438. Other similar components may be provided on the communication device 400 as well and optionally communicatively coupled to the microprocessor 438. Other communication subsystems 440 and other communication device subsystems 442 are generally indicated as being functionally connected with the microprocessor 438 as well. An example of a communication subsystem 440 is a short range communication system such as BLUETOOTH® communication module or a WI-FI® communication module (a communication module in compliance with IEEE 802.11b) and associated circuits and components. Additionally, the microprocessor 438 is able to perform operating system functions and enables execution of programs on the communication device 400. In some embodiments not all of the above components may be included in the communication device 400. For example, in at least one embodiment the keyboard 432 is not provided as a separate component and is instead integrated with a touchscreen as described below.

The auxiliary I/O subsystem 428 can take the form of a variety of different navigation tools (multi-directional or single-directional) such as a trackball navigation tool 321 as illustrated in the exemplary embodiment shown in FIG. 3, or a thumbwheel, a navigation pad, a joystick, touch-sensitive interface, or other I/O interface. These navigation tools may be located on the front surface of the communication device 400 or may be located on any exterior surface of the communication device 400. Other auxiliary I/O subsystems may include external display devices and externally connected keyboards (not shown). While the above examples have been provided in relation to the auxiliary I/O subsystem 428, other subsystems capable of providing input or receiving output from the communication device 400 are considered within the scope of this disclosure. Additionally, other keys may be placed along the side of the communication device 300 to function as escape keys, volume control keys, scrolling keys, power switches, or user programmable keys, and may likewise be programmed accordingly.

The keyboard 432 can include a plurality of keys that can be of a physical nature such as actuable buttons, or they can be of a software nature, typically constituted by representations of physical keys on a display screen 422 (referred to herein as “virtual keys”). It is also contemplated that the user input can be provided as a combination of the two types of keys. Each key of the plurality of keys has at least one actuable action which can be the input of a character, a command or a function. In this context, “characters” are contemplated to exemplarily include alphabetic letters, language symbols, numbers, punctuation, insignias, icons, pictures, and even a blank space.

In the case of virtual keys, the indicia for the respective keys are shown on the display screen 422, which in one embodiment is enabled by touching the display screen 422, for example, with a stylus, finger, or other pointer, to generate the character or activate the indicated command or function. Some examples of display screens 422 capable of detecting a touch include resistive, capacitive, projected capacitive, infrared and surface acoustic wave (SAW) touch screens.

Physical and virtual keys can be combined in many different ways as appreciated by those skilled in the art. In one embodiment, physical and virtual keys are combined such that the plurality of enabled keys for a particular program or feature of the communication device 400 is shown on the display screen 422 in the same configuration as the physical keys. Using this configuration, the operator can select the appropriate physical key corresponding to what is shown on the display screen 422. Thus, the desired character, command or function is obtained by depressing the physical key corresponding to the character, command or function displayed at a corresponding position on the display screen 422, rather than touching the display screen 422.

Furthermore, the communication device, e.g. 400, 300 is equipped with components to enable operation of various programs, as shown in FIG. 4. In an exemplary embodiment, the flash memory 424 is enabled to provide a storage location for the operating system 457, device programs 458, and data. The operating system 457 is generally configured to manage other programs 458 that are also stored in memory 424 and executable on the processor 438. The operating system 457 honors requests for services made by programs 458 through predefined program 458 interfaces. More specifically, the operating system 457 typically determines the order in which multiple programs 458 are executed on the processor 438 and the execution time allotted for each program 458, manages the sharing of memory 424 among multiple programs 458, handles input and output to and from other device subsystems 442, and so on. In addition, operators can typically interact directly with the operating system 457 through a user interface usually including the keyboard 432 and display screen 422. While in an exemplary embodiment the operating system 457 is stored in flash memory 424, the operating system 457 in other embodiments is stored in read-only memory (ROM) or similar storage element (not shown). As those skilled in the art will appreciate, the operating system 457, device program 458 or parts thereof may be loaded in RAM 426 or other volatile memory.

When the communication device 400 is enabled for two-way communication within the wireless communication network 419, it can send and receive signals from a mobile communication service. Examples of communication systems enabled for two-way communication include, but are not limited to, the General Packet Radio Service (GPRS) network, the Universal Mobile Telecommunication Service (UMTS) network, the Enhanced Data for Global Evolution (EDGE) network, the Code Division Multiple Access (CDMA) network, High-Speed Packet Access (HSPA) networks, Universal Mobile Telecommunication Service Time Division Duplexing (UMTS-TDD), Ultra Mobile Broadband (UMB) networks, Worldwide Interoperability for Microwave Access (WiMAX), and other networks that can be used for data and voice, or just data or voice. For the systems listed above, the communication device 400 may use a unique identifier to enable the communication device 400 to transmit and receive signals from the communication network 419. Other systems may not use such identifying information. GPRS, UMTS, and EDGE use a Subscriber Identity Module (SIM) in order to allow communication with the communication network 419. Likewise, most CDMA systems use a Removable User Identity Module (RUIM) in order to communicate with the CDMA network. The RUIM and SIM card can be used in multiple different communication devices 400. The communication device 400 may be able to operate some features without a SIM/RUIM card, but it will not be able to communicate with the network 419. A SIM/RUIM interface 444 located within the communication device 400 allows for removal or insertion of a SIM/RUIM card (not shown). The SIM/RUIM card features memory and holds key configurations 451, and other information 453 such as identification and subscriber related information. With a properly enabled communication device 400, two-way communication between the communication device 400 and communication network 419 is possible.

If the communication device 400 is enabled as described above or the communication network 419 does not use such enablement, the two-way communication enabled communication device 400 is able to both transmit and receive information from the communication network 419. The transfer of communication can be from the communication device 400 or to the communication device 400. In order to communicate with the communication network 419, the device 400 can be equipped with an integral or internal antenna 418 for transmitting signals to the communication network 419. Likewise the device 400 can be equipped with another antenna 416 for receiving communication from the communication network 419. These antennae (416, 418) in another exemplary embodiment are combined into a single antenna (not shown). As one skilled in the art would appreciate, the antenna or antennae (416, 418) in another embodiment can be externally mounted on the communication device 400.

When equipped for two-way communication, the communication device 400 features a communication subsystem 411. As is understood in the art, this communication subsystem 411 is modified so that it can support the operational needs of the communication device 400. The sub-system 411 includes a transmitter 414 and receiver 412 including the associated antenna or antennae (416, 418) as described above, local oscillators (LOs) 413, and a processing module that in the presently described exemplary embodiment is a digital signal processor (DSP) 420.

It is contemplated that communication by the communication device 400 with the wireless network 419 can be any type of communication that both the wireless network 419 and communication device 400 are enabled to transmit, receive and process. In general, these can be classified as voice and data. Voice communication generally refers to communication in which signals for audible sounds are transmitted by the communication device 400 through the communication network 419. Data generally refers to all other types of communication that the communication device 400 is capable of performing within the constraints of the wireless network 419.

Example device programs that can depend on such data include email, contacts and calendars. For each such program, synchronization with home-based versions of the program can be desirable for either or both of their long term and short term utility. As an example, emails are often time-sensitive, so substantially real time (or near-real time) synchronization may be desired. Contacts, on the other hand, can be usually updated less frequently without inconvenience. Therefore, the utility of the communication device 400 is enhanced when connectable within a communication system, and when connectable on a wireless basis in a network 419 in which voice, text messaging, and other data transfer are accommodated. Device 400 can include programs such as a web browser, a file browser, and client programs for interacting with server programs.

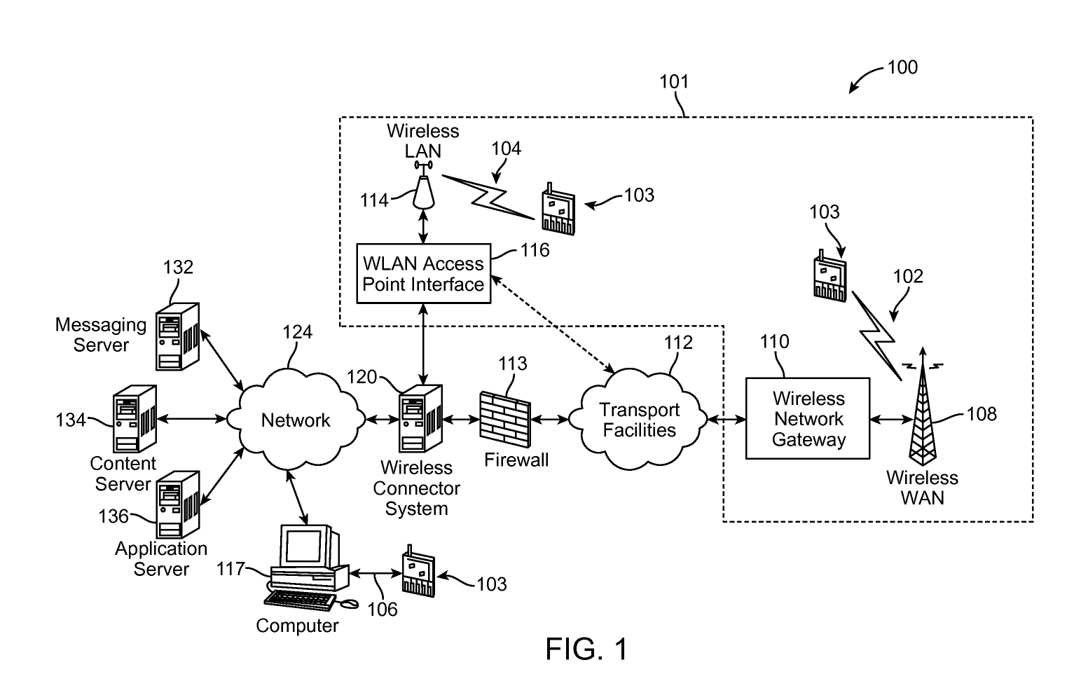

With reference to FIGS. 1 through 4, devices, e.g., 103, 300, 400, for use in the technology can be characterized by an identification number assigned to the device. Such identification numbers cannot be changed and are locked to each device. For example, a BlackBerry PIN is an eight character hexadecimal identification number uniquely assigned to each BlackBerry device.

In order to facilitate an understanding of environments in which example embodiments described herein can operate, reference is made to FIG. 1 that shows, in block diagram form, a communication system 100 in which embodiments of the technology can be applied. The communication system 100 may comprise a number of mobile communication devices 103 that may be connected to the remainder of system 100 in any of several different ways. Accordingly, several instances of mobile communication devices 103 are depicted in FIG. 1 employing different example ways of connecting to system 100.

These figures are exemplary only, and those persons skilled in the art will appreciate that additional elements and modifications may be incorporated to make the communication device, e.g., 103, 300, 400 work in particular network environments. While in the illustrated embodiments, the communication devices, e.g., 103, 300, 400 are smart phones, however, in other embodiments, the communication devices 300 may be personal digital assistants (PDA), laptop computers, desktop computers, servers, or other communication device capable of sending and receiving electronic messages.

Referring to FIG. 1, mobile communication devices 103 are connected to a wireless network 101 that may comprise one or more of a Wireless Wide Area Network (WWAN) 102 (e.g., 419) and a Wireless Local Area Network (WLAN) 104 or other suitable network arrangements. In some embodiments, the mobile communication devices 103 are configured to communicate over both the WWAN 102 and WLAN 104, and to roam between these networks. In some embodiments, the wireless network 101 may comprise multiple WWANs 102 and WLANs 104.

The WWAN 102 may be implemented as any suitable wireless access network technology. By way of example, but not limitation, the WWAN 102 may be implemented as a wireless network that includes a number of transceiver base stations 108 (one of which is shown in FIG. 4, and such as 419) where each of the base stations 108 provides wireless Radio Frequency (RF) coverage to a corresponding area or cell. The WWAN 102 is typically operated by a mobile network service provider that provides subscription packages to users of the mobile communication devices 103. In some embodiments, the WWAN 102 conforms to one or more of the following wireless network types: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) CDMA2000, EDGE (Enhanced Data rates for GSM Evolution), UMTS (Universal Mobile Telecommunication Systems), HSPDA (High-Speed Downlink Packet Access), IEEE 802.16e (also referred to as Worldwide Interoperability for Microwave Access or “WiMAX”), or various other networks. Although WWAN 102 is described as a “Wide-Area” network, that term is intended herein also to incorporate wireless Metropolitan Area Networks (WMAN) and other similar technologies for providing coordinated service wirelessly over an area larger than that covered by typical WLANs.

The WWAN 102 may further comprise a wireless network gateway 110 that connects the mobile communication devices 103 to transport facilities 112, and through the transport facilities 112 to a wireless connector system 120. Transport facilities may include one or more private networks or lines, the Internet, a virtual private network, or any other suitable network. The wireless connector system 120 may be operated, for example, by an organization or enterprise such as a corporation, university, or governmental department that allows access to a network 124 such as an internal or enterprise network (e.g., an intranet) and its resources, or the wireless connector system 120 may be operated by a mobile network provider. In some embodiments, the network 124 may be realized using the Internet rather than or in addition to an internal or enterprise network.

The wireless network gateway 110 provides an interface between the wireless connector system 120 and the WWAN 102, which facilitates communication between the mobile communication devices 103 and other devices (not shown) connected, directly or indirectly, to the WWAN 102. Accordingly, communications sent via the mobile communication devices 103 are transported via the WWAN 102 and the wireless network gateway 110 through transport facilities 112 to the wireless connector system 120. Communications sent from the wireless connector system 120 are received by the wireless network gateway 110 and transported via the WWAN 102 to the mobile communication devices 103.

The WLAN 104 comprises a wireless network that, in some embodiments, conforms to IEEE 802.11x standards (sometimes referred to as Wi-Fi™) such as, for example, the IEEE 802.11a, 802.11b and/or 802.11g standard. Other communication protocols may be used for the WLAN 104 in other embodiments such as, for example, IEEE 802.11n, IEEE 802.16e (also referred to as Worldwide Interoperability for Microwave Access or “WiMAX”), or IEEE 802.20 (also referred to as Mobile Wireless Broadband Access). The WLAN 104 includes one or more wireless RF Access Points (AP) 114 (one of which is shown in FIG. 1) that collectively provide a WLAN coverage area.

The WLAN 104 may be a personal network of the user, an enterprise network, or a hotspot offered by an internet service provider (ISP), a mobile network provider, or a property owner in a public or semi-public area, for example. The access points 114 are connected to an access point (AP) interface 116 that may connect to the wireless connector system 120 directly (for example, if the access point 114 is part of an enterprise WLAN 104 in which the wireless connector system 120 resides), or indirectly as indicated by the dashed line in FIG. 1 via the transport facilities 112 if the access point 114 is a personal Wi-Fi network or Wi-Fi hotspot (in which case a mechanism for securely connecting to the wireless connector system 120, such as a virtual private network (VPN), may be used). The AP interface 116 provides translation and routing services between the access points 114 and the wireless connector system 120 to facilitate communication, directly or indirectly, with the wireless connector system 120.

The wireless connector system 120 may be implemented as one or more servers, and is typically located behind a firewall 113. The wireless connector system 120 manages communications, including email, Hypertext Transfer Protocol (HTTP), HTTP Secure (HTTPS), and Server Message Block (SMB) a.k.a. Common Internet File System (CIFS) communications to and from a set of managed mobile communication devices 103. The wireless connector system 120 also provides administrative control and management capabilities over users and mobile communication devices 103 that may connect to the wireless connector system 120.

The wireless connector system 120 allows the mobile communication devices 103 to access the network 124 and connected resources and services such as a messaging server 132 (for example, a Microsoft Exchange, IBM Lotus® Domino®, or Novell® GroupWise® email server for providing e-mail messages to devices 103; Microsoft Office Communications Server of Live Communications Server, IBM Lotus SameTime®, or Novell GroupWise server for providing instant messaging (IM) to devices 103), a content server 134 for providing content such as Intranet file services to devices 103, or application servers 136 for implementing server-based Intranet applications to devices 103.

The wireless connector system 120 typically provides a secure exchange of data (e.g., email messages, personal information manager (PIM) data, and IM data) with the mobile communication devices 103. In some embodiments, communications between the wireless connector system 120 and the mobile communication devices 103 are encrypted. In some embodiments, communications are encrypted using a symmetric encryption key implemented using Advanced Encryption Standard (AES) or Triple Data Encryption Standard (Triple DES) encryption. Private encryption keys are generated in a secure, two-way authenticated environment and are used for both encryption and decryption of data. In some embodiments, the private encryption key is stored only in the user's mailbox on the messaging server 132 and on the mobile communication device 103, and can typically be regenerated by the user on mobile communication devices 103. Data sent to the mobile communication devices 103 is encrypted by the wireless connector system 120 using the private encryption key retrieved from the user's mailbox. The encrypted data, when received on the mobile communication devices 103, is decrypted using the private encryption key stored in memory. Similarly, data sent to the wireless connector system 120 from the mobile communication devices 103 is encrypted using the private encryption key stored in the memory of the mobile communication device 103. The encrypted data, when received on the wireless connector system 120, is decrypted using the private encryption key retrieved from the user's mailbox.

The wireless network gateway 110 is adapted to send data packets received from the mobile communication device 103 over the WWAN 102 to the wireless connector system 120. The wireless connector system 120 then sends the data packets to the appropriate connection point such as the messaging server 132 or content servers 134 or application server 136. Conversely, the wireless connector system 120 sends data packets received, for example, from the messaging server 132, content/file servers 134, and application servers 136 to the wireless network gateway 110 that then transmit the data packets to the destination mobile communication device 103. The AP interfaces 116 of the WLAN 104 provide similar sending/receiving functions between the mobile communication device 103, the wireless connector system 120 and network connection point such as the messaging server 132, content/file server 134, and application server 136.

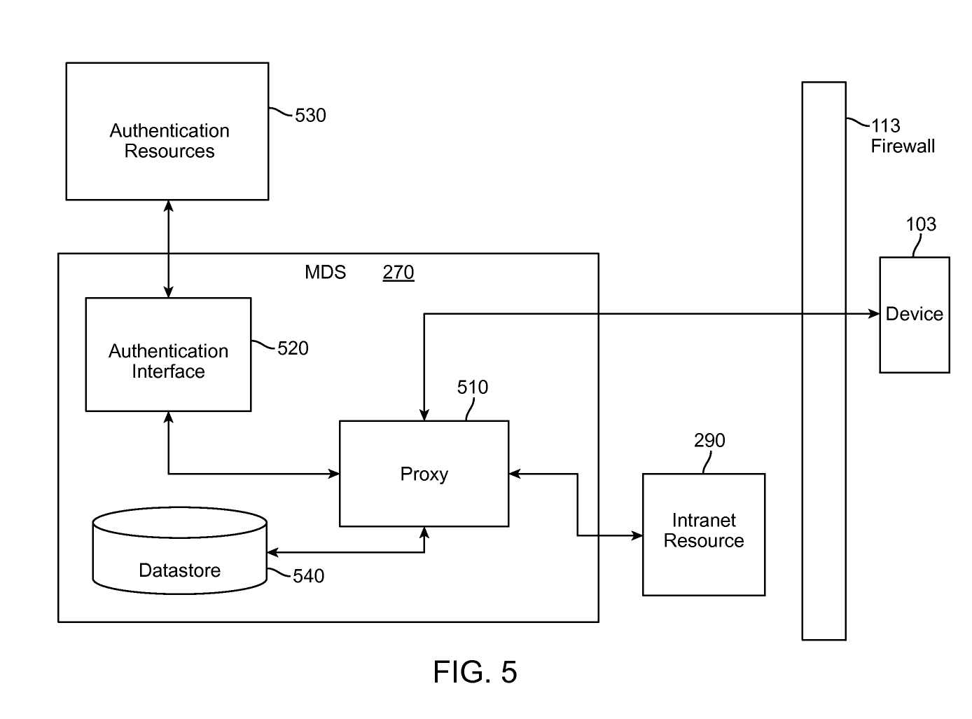

The network 124 may comprise a private local area network, metropolitan area network, wide area network, an enterprise intranet, the public Internet, or combinations thereof and may include virtual networks constructed using any of these, alone, or in combination. For applications of the present technology an enterprise intranet is preferred, though the determining factor is whether the entities such as the user, the device 103, wireless connector system 120 (including MDS 270 with proxy 510 as shown in FIG. 5), and intranet resources (e.g., application servers 136, content/file servers 134) are within the range of the authentication resources 530. A mobile communication device 103 may alternatively connect to the wireless connector system 120 using a computer 117, such as desktop or notebook computer, via the network 124. A link 106 may be provided for exchanging information between the mobile communication device 103 and a computer 117 connected to the wireless connector system 120. The link 106 may comprise one or both of a physical interface and short-range wireless communication interface. The physical interface may comprise one or combinations of an Ethernet connection, Universal Serial Bus (USB) connection, Firewire™ (also known as an IEEE 1394 interface) connection, or other serial data connection, via respective ports or interfaces of the mobile communication device 103 and computer 117. The short-range wireless communication interface may be a personal area network (PAN) interface. A Personal Area Network is a wireless point-to-point connection meaning no physical cables are used to connect the two end points. The short-range wireless communication interface may comprise one or a combination of an infrared (IR) connection such as an Infrared Data Association (IrDA) connection, a short-range radio frequency (RF) connection such as one specified by IEEE 802.15.1 or the BLUETOOTH special interest group, or IEEE 802.15.3a, also referred to as UltraWideband (UWB), or other PAN connection.

It will be appreciated that the above-described communication system is provided for the purpose of illustration only, and that the above-described communication system comprises one possible communication network configuration of a multitude of possible configurations for use with the mobile communication devices 103. Suitable variations of the communication system will be understood to a person of skill in the art and are intended to fall within the scope of the present disclosure.

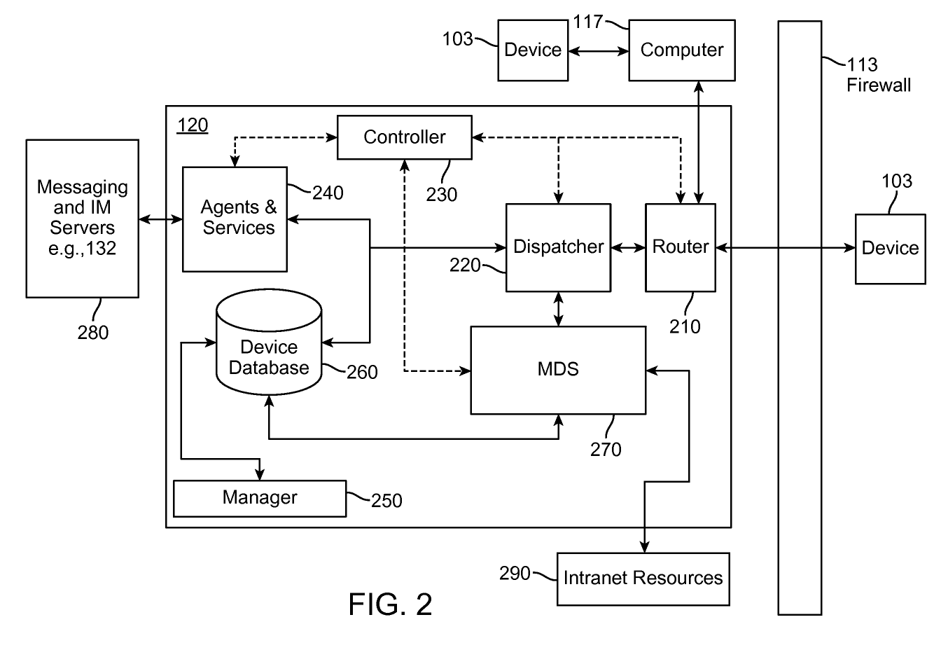

Referring to FIG. 2, a wireless connector system 120 for use with embodiments of the present technology will now be described in more detail. The wireless connector system 120 can be implemented using any known general purpose computer technology, and can, for example be realized as one or more microprocessor-based server computers implementing one or more server applications configured for performing the processes and functions described herein. The wireless connector system 120 is configured to implement a number of components or modules, including by way of non-limiting example, a router 210, dispatcher 220, controller 230, agents/services 240, a device manager 250, databases 260, and mobile data services (MDS) 270. The wireless connector system 120 may include more of or fewer than the modules listed above. In some embodiments, the wireless connector system 120 includes one or more microprocessors that operate under stored program control and execute software to implement these modules. The software can for example be stored in memory such as persistent memory. The router 210, dispatcher 220, controller 230, agents/services 240, manager 250, databases 260, and MDS 270 modules can, among other things, each be implemented through stand-alone software applications, or combined together in one or more software applications, or as part of another software application. In some embodiments, the functions performed by each of the above identified modules can be realized as a plurality of independent elements, rather than a single integrated element, and any one or more of these elements can be implemented as parts of other software applications.

The router 210 connects to the wireless network 101 (FIG. 1) to send data to and from devices 103. It also sends data within the intranet to devices 103 that are connected to computers 117 on the intranet, e.g., 124. The dispatcher 220 compresses and encrypts data sent to and from devices 103. It sends data through the router 210 to and from the wireless network 101. The controller 230 monitors the wireless connector system 120 components and restarts them if they stop responding. The agents/services 240 facilitate various functionality related to devices 103, including: providing a connection between devices 103 and enterprise services 280 such as instant messaging, e-mail, calendar, contacts, attachment conversion and viewing, synchronization, etc. The agent/services 240, along with the manager 250 also provide administrative services.

Databases 260, accessible by the various other components of the wireless connector system 120, contain configuration data that the system 120 uses. The databases 260 can include the following data: details about the connection from the system 120 to the wireless network 101; user list; address mappings between device identifiers and e-mail addresses; and a read-only copy of each master encryption key. The databases 260 can also serve as a repository for device applications that can be installed on devices 103 using the MDS 270.

The MDS 270 enables devices 103 to access web content, the Internet, and files and applications available as network resources 290, e.g., 134, 136 available on the organization's intranet 124. This connection service processes requests for web content from browsers and Java® applications executing on a device 103. The mobile data services (MDS) 270 also manages TCP/IP and HTTP connections between applications executing on a device 103 and intranet application servers, web servers, or databases inside the firewall 113.

As disclosed above, the wireless connector system 120 allows the mobile communication devices 103 to access the enterprise network resources 290, such as application servers 136 and content/file servers 134, for implementing server-based applications to mobile communication devices 103. Often, such resources are access-restricted, e.g., requiring a user to enter a username and password for access. Embodiments of the present technology reduce the need for certain device users to enter a username and password when accessing intranet resources. The wireless connector system 120 can map device identifiers to user identification required for access to access-restricted intranet resources.

Referring to FIG. 5, in some embodiments, the MDS 270 of a wireless connection system 120 (FIG. 2) includes a proxy 510 between a device 103 and an intranet resource 290. The wireless connection system 120 also includes an authentication interface 520 to authentication resources 530, along with a database 540 available to relate a device identifier to a user identifier (e.g., a username, an e-mail address, user identifier of an AD account or corporate account). In some embodiments, the communication channel between the MDS 270 and the Authentication resources is characterized by the Kerberos protocol with AD extensions over TCP/IP. In some embodiments, the MDS 270 internal database 540 retains a cache of information extracted from wireless connector system 120 device database 260. In other embodiments, the proxy 510 also performs the functions of the authentication interface 520.

In some embodiments, the authentication resources 530 are in communication with the MDS 270 via network 124. In some embodiments, the authentication resources include Microsoft Active Directory® (AD) implementing Lightweight Directory Access Protocol (LDAP)-like directory services and Kerberos-based authentication services.

For simplicity, FIG. 5 does not show intervening nodes, e.g., transport facilities 112, wireless network gateway 110, and Wireless WAN 102 are not shown between device 103 and MDS 270. Further, some higher-level components are not shown, e.g., the wireless data connector 120 that the MDS 270 can be part of is not shown.

Embodiments of the technology use the proxy 510 to serve as an intermediary between a device 103 and an intranet resource 290. When an intranet resource 290 challenges a request from a device 103, the proxy 510 obtains appropriate credentials from the authentication resources 530 via the authentication interface 520, according to pre-configured protocols establishing a delegation user, and then renews the request to the intranet resource 290.

In embodiments of the technology, a delegation user acts on behalf of a device user with authentication resources 530. The delegation user can be configured as a service account in the authentication resource 530 trusted for presenting (e.g., via the proxy 510) credentials on behalf of specified users to specified intranet services running on intranet resources 290 for use with any authentication protocol. In some embodiments, the delegation user's password never expires. The delegation user profile can be read from a database, e.g., database 260, datastores 540, at startup of wireless connector system 120 and updated whenever the database is refreshed.

Some embodiments of the technology include Quest® Single Sign-on for Java™ (“Quest SSO”) as the authentication interface 520. Quest SSO can serve as an intermediary between Java applications (running on a device 103 and in the proxy 510) and authentication resources (e.g., Active Directory) for managing a delegation user and for handling requests for credentials. Where the proxy 510 can communicate directly with the authentication resources 530 for those purposes, a separate authentication interface 520 is not required.

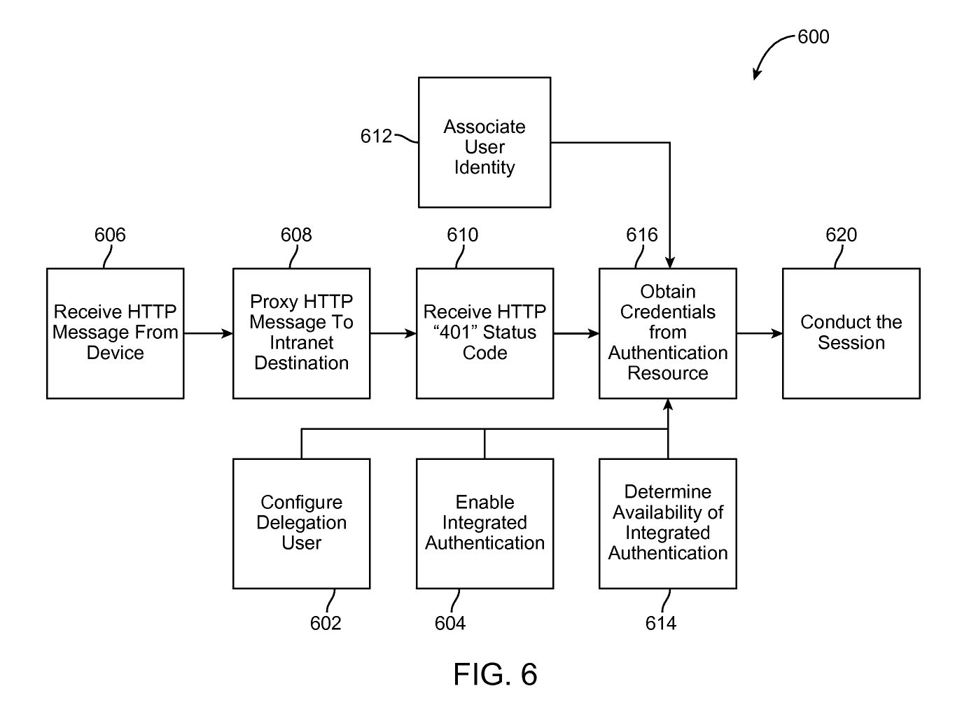

Referring to FIG. 6, a method 600 of the technology for integrated authentication in support of HTTP requests from a device 103 to an application server 136 can begin with configuring delegation user 602 according to the requirements of the domain's authentication resources 530 and enabling integrated authentication 604 for the domain. As noted above, configuration of the delegation user can be performed through a graphical user interface (GUI) of the authentication resource 530.

In some embodiments, a configured delegation user is read by the proxy 510 from the device database 260 at wireless connector system 120 startup, and when the database 260 is refreshed. Using the delegation user's credentials, a Ticket Granting Ticket (TGT) service is created for the delegation user in the authentication resources 530. The TGT can be automatically renewed if it expires. In these embodiments, there is one TGT for a delegation user that is used to generate credentials for device requests (e.g., HTTP requests, file system requests). The TGT is recreated if the name of the delegation user or delegation user password is changed. The delegation user and password can be encrypted in the database 260, and where encrypted will be decrypted by the MDS 270 for MDS use.

The proxy 510 can receive an HTTP request 606 from a device 103. Absent entry of a username and password at the device 103, such requests are characterized by the hardware identifier, e.g., a BlackBerry PIN, for the device 103.

Received HTTP requests are proxied 608, e.g., by the proxy 510, to the destination identified in the request, e.g., an intranet resource such as an application server 136.

If the intranet resource, e.g., 136, requires authentication in order to respond, an HTTP “401 Unauthorized” status code may be sent by the intranet resource, e.g., 136. The proxy 510 receives 610 the HTTP “401 Unauthorized” status code. In some embodiments, the response contains information regarding the type of authentication accepted by the intranet resource e.g., basic authentication, Kerberos, or negotiated authentication. Some embodiments of the present technology are implicated when Kerberos or negotiated authentication are indicated. In some embodiments of the technology, receipt of an HTTP “401 Unauthorized” status code is not required.

Before responding to receipt of an HTTP “401 Unauthorized” status code, the technology associates 612 the hardware identifier in the HTTP message received from the device 103 with a user identity. In some embodiments, the technology queries device database 260 to associate the device 103 with a user identity. In some embodiments, the technology maintains a cache of hardware identifier-to-user identity data in a datastore such as datastore 540. In embodiments relying on Microsoft™ Active Directory (AD), the user identity retrieved from the datastore can be used to retrieve the AD login name for the user.

Before responding to an HTTP “401 Unauthorized” status code, the proxy can determine if integrated authentication is available 614 under the circumstances. The technology can check for circumstances such as: whether integrated authentication is enabled in the domain; whether the request is in compliance with URL pattern rules (e.g., stored in the database 260) for the identified user; whether the delegation user is configured; and whether the requested URL is in the domain established for integrated authentication. If integrated authentication is not available, the technology can prompt the device user for the appropriate information (e.g., username and password) required by the destination URL.

Upon associating the device hardware identifier with a user identity and confirming that integrated authentication is available under the circumstances, the proxy 510 obtains, e.g., via the authentication interface 520, the identified user's credentials 616 required by destination URL from the authentication resource 530. Where the authentication resource 530 is Active Directory (AD) implementing a Kerberos extension, the proxy 510 uses the delegation user to obtain a Ticket Granting Ticket (TGT) on behalf of the user. The delegation user receives a time stamped TGT, and then contacts the Kerberos ticket granting server of the AD. Using the TGT it demonstrates its delegated identity and asks for a service. If the user is eligible for the service, then the ticket granting server sends a session ticket to proxy 510.

After obtaining the credentials required by the destination URL, the proxy 510 resends the initial HTTP request with the proper credentials and conducts the session as a proxy for the device. Where the authentication resource is AD implementing a Kerberos extension, the proxy base64-encodes the session ticket, and adds the encoded session ticket to the header of the HTTP request.

The proxy 510 then contacts the intranet resource 136 on behalf of the user, and using this session ticket, the proxy proves that the user has been approved to receive the service offered by the intranet resource.

The steps described herein are described in a logical order, but do not have to be performed in the exact order described. Alternate ordering, such as enabling integrated authentication concurrent with or before configuring a delegation user, is contemplated. Other possible alternate ordering includes checking for integration authentication enablement, URL request eligibility with regard to domain, and user identity in various orders.

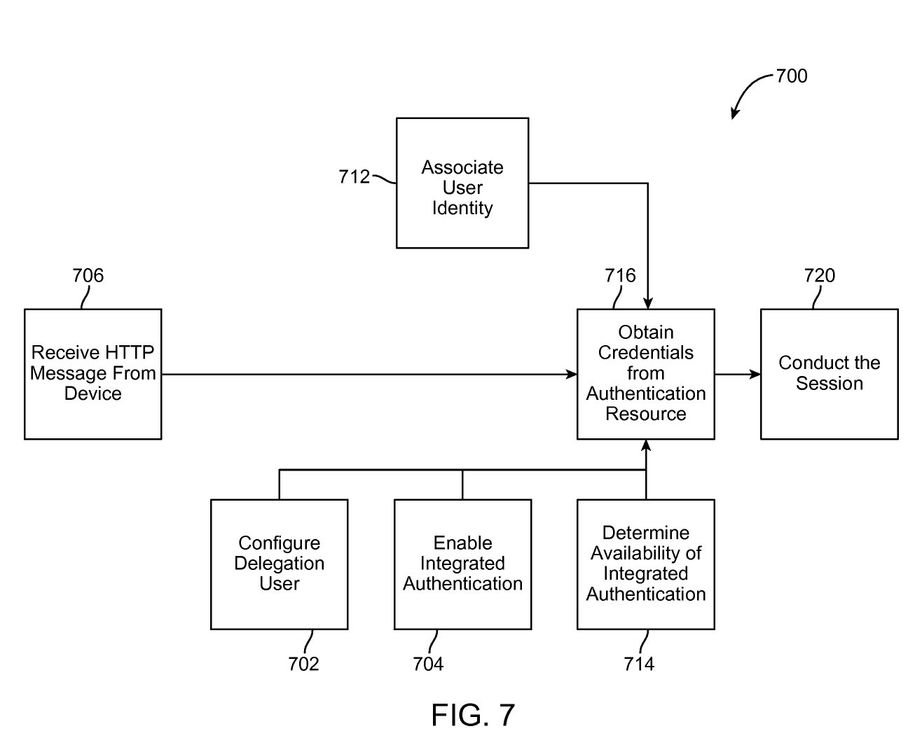

Referring to FIG. 7, a method 700 of the technology for integrated authentication in support of file requests from a device 103 to an intranet resource, e.g., a content/file server 134, can begin with configuring delegation user 702 according to the requirements of the domain's authentication resources 530 and enabling integrated authentication 704 for the domain. As noted above, configuration of the delegation user can be performed through a graphical user interface (GUI) of the authentication resource 530.

In some embodiments, the delegation user is read from the device database 260 at wireless connector system 120 startup, and when the database 260 is refreshed. Using the delegation user's credentials a Ticket Granting Ticket (TGT) service is created for the delegation user. The TGT can be automatically renewed if it expires. In these embodiments, there is one TGT for each delegation user that is used to generate credentials for device requests (e.g., file system requests). The TGT is recreated if the name of the delegation user or delegation user password is changed. The delegation user and password can be encrypted in the database 260, and where encrypted will be decrypted by the MDS 270 for MDS use.

The proxy 510 can receive a file system request 706, e.g. a Server Message Block (SMB)/Common Internet File System (CIFS) request from a device 103. For example, the request can come from a remote file explorer of the device 103. Absent entry of a username and password at the device 103, such requests are characterized by the hardware identifier, e.g., a BlackBerry PIN, for the device 103.

Before responding to receipt of a file system request, the technology associates 712 the hardware identifier in the request received from the device 103 with a user identity. In some embodiments, the technology queries device database 260 to associate the device 103 with a user identity. In some embodiments, the technology maintains a cache of hardware identifier-to-user identity data in a datastore such as datastore 540. In embodiments relying on AD, the user identity retrieved from the datastore can be used to retrieve the AD login name for the user.

Before responding to the file system request, the proxy 510 can determine if integrated authentication is available 714 under the circumstances. The proxy 510 can check for circumstances such as: whether integrated authentication is enabled in the domain; whether the request is in compliance with URL pattern rules (e.g., stored in the database 260) for the identified user; whether the delegation user is configured; and whether the requested URL is in the domain established for integrated authentication. If integrated authentication is not available, the proxy can prompt the device user for the appropriate information (e.g., username and password) required by the destination URL.

Upon associating the device hardware identifier with a user identity and confirming that integrated authentication is available under the circumstances, the proxy 510 obtains the identified user's credentials 716 required by destination URL from the authentication resource 530. Where the authentication resource 530 is Active Directory (AD) implementing a Kerberos extension, the proxy 510 uses the delegation user to obtain a Ticket Granting Ticket (TGT) on behalf of the user. The delegation user receives a time stamped TGT, and then contacts the Kerberos ticket granting server. Using the TGT it demonstrates its delegated identity and asks for a service. If the user is eligible for the service, then the ticket granting server sends a session ticket to proxy 510.

After obtaining the credentials required by the destination URL, the proxy 510 then performs the action of the file request by contacting the intranet resource 134 on behalf of the user, and using the session ticket, the proxy 510 proves that the user has been approved to receive the service offered by the intranet resource 134.

As an example use case, suppose a company has a personal leave software application available on an application server 136 of its intranet 124. The application is accessible through a conventional HTTP browser running on any platform served by the MDS 270 and having access to the application server 136, e.g., an enterprise-associated device 103 with access to the intranet through any one or more of wireless network 102, WLAN 104, or connection 106. The browser may also be on computer 117 if the computer is served by the MDS 270. Absent the present technology, employees attempting to access the application are prompted for corporate user ID and password.

Under use of the present technology, a URL pattern can be defined for http://go/vacation for both HTTP and HTTPS in the domain of the MDS 270, and a rule can be defined to allow this pattern to be used and assigned to the group that defines all full time employees. When a user of an enterprise-associated device 103 logs on to a device (e.g., using a device password), and attempts to access http://go/vacation using a browser, the MDS 270 checks if the user is allowed to access the site. If the user is allowed to access the site, the MDS 270, e.g., via the proxy 510, sends the HTTP request and (from a URL requiring authentication) receives an HTTP “401 Unauthorized” response. For a response identifying either Kerberos-type or negotiated authentication, the MDS 270 checks if the requesting user has integrated authentication allowed for this site. The MDS 270 then uses the delegation user to receive a TGT for the user associated with the device, and then sends the HTTP request again with the encoded TGT. Typically, the site will respond to the MDS 270 with an HTTP 200 message and the requested page showing the user's personal leave information. While the above use case identifies the MDS 270 generally as performing these functions, the remainder of the disclosure identifies that some, or all, of the functions can be performed by the proxy 510 and authentication interface 520 of the MDS 270.

In the above-described embodiments, the proxy 510 of the MDS 270 relates a device identifier with a user identity. In other embodiments, this relation is accomplished using a certificate that can be stored on the device 103.

The present technology can take the form of hardware, software or both hardware and software elements. In some embodiments, the technology is implemented in software, which includes but is not limited to firmware, resident software, microcode, an FPGA or ASIC, etc. In particular, for real-time or near real-time use, an FPGA or ASIC implementation is desirable.

Furthermore, the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. Both processors and program code for implementing each as aspect of the technology can be centralized or distributed (or a combination thereof) as known to those skilled in the art.

A data processing system suitable for storing a computer program product of the present technology and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations. In some embodiments, the data processing system is implemented using one or both of FPGAs and ASICs.

1. A computer-implemented method for authentication to a network resource of a user associated with a mobile communication device, the method comprising:
receiving a message from a mobile communication device,
the message including a hardware identifier of the device, and
the message identifying the network resource as a destination of a first message;
associating a user identity with the hardware identifier, the user identity sufficient to obtain session credentials from an authentication resource;
obtaining session credentials from the authentication resource; and
using the session credentials to authenticate the associated user identity to the network resource.

2. The computer-implemented method of claim 1 wherein:
the method is performed inside a firewall;
the network resource is inside the firewall; and
the device is outside the firewall.

3. The computer-implemented method of claim 1:
wherein the message comprises one of:
an HTTP message, and
an HTTPS message; and
further comprising:
after the receiving the message, and before the obtaining session credentials, proxying the received message to the network resource;
receiving a “401 Unauthorized” status code from the intranet resource in response to the proxied message, the status code indicating an option other than basic authentication.

4. The computer-implemented method of claim 1 wherein:
the message comprises a file request.

5. The computer-implemented method of claim 4 wherein:
the file request comprises a Server Message Block (SMB)/Common Internet File System (CIFS) message.

6. A computer program product for authentication to a network resource of a user associated with a mobile communication device, the computer program product comprising:
a least one computer readable medium; and
at least one program module,
stored on the at least one medium, and
operable, upon execution by at least one processor to:
receive a message from a mobile communication device,
the message including a hardware identifier of the device, and
the message identifying the network resource as a destination of a first message;
associate a user identity with the hardware identifier, the user identity sufficient to obtain session credentials from an authentication resource;
obtain session credentials from the authentication resource; and
use the session credentials to authenticate the associated user identity to the network resource.

7. The computer program product of claim 6 wherein:
each at least one processor is inside a firewall;
the network resource is inside the firewall; and
the device is outside the firewall.

8. The computer program product of claim 6:
wherein the message comprises one of:
an HTTP message, and
an HTTPS message; and
wherein the at least one program module is further operable to:
after the receiving the message, and before the obtaining session credentials, proxy the received message to the network resource;
receive a “401 Unauthorized” status code from the intranet resource in response to the proxied message, the status code indicating an option other than basic authentication.

9. The computer program product of claim 6 wherein:
the message comprises a file request.

10. The computer program product of claim 9 wherein:
the file request comprises a Server Message Block (SMB)/Common Internet File System (CIFS) message.

11. A system for authentication to a network resource of a user associated with a mobile communication device, the system comprising:
at least one processor,
at least one computer readable medium in communication with the processor;
at least one program module,
stored on the at least one medium, and
operable to, upon execution by the at least one processor:
receive a message from a mobile communication device,
the message including a hardware identifier of the device, and the message identifying the network resource as a destination of a first message;
associate a user identity with the hardware identifier, the user identity sufficient to obtain session credentials from an authentication resource;
obtain session credentials from the authentication resource; and
use the session credentials to authenticate the associated user identity to the network resource.

12. The system of claim 11 wherein:
each at least one processor is inside a firewall;
the network resource is inside the firewall; and
the device is outside the firewall.

13. The system of claim 11:
wherein the message comprises one of:
an HTTP message, and
an HTTPS message; and
wherein the at least one program module is further operable to:
after the receiving the message, and before the obtaining session credentials, proxy the received message to the network resource;
receive a “401 Unauthorized” status code from the intranet resource in response to the proxied message, the status code indicating an option other than basic authentication.

14. The system of claim 11 wherein:
the message comprises a file request.

15. The system of claim 14 wherein:
the file request comprises a Server Message Block (SMB)/Common Internet File System (CIFS) message.
